(19) United States
(12) Patent Application Publication
(10) Pub. No.: US 2015/0056570 A1
(43) Pub. Date: Feb. 26, 2015

(54) DENTAL WATER JET

(71) Applicant: Sudhanshu Kansal, New Delhi (IN)

(72) Inventor: Sudhanshu Kansal, New Delhi (IN)

(21) Appl. No.: 14/383,111

(22) PCT Filed: Mar. 12, 2012
(86) PCT No.: PCT/IN2012/000169

§ 371 Date: Sep. 5, 2014

(30) Foreign Application Priority Data
Mar. 10, 2011 (IN) 674/DEL/2011

(51) Int. Cl. A61C 17/02; A61C 15/04; A61H 13/00; A61C 17/022

(52) U.S. Cl. CPC A61C 17/0202; A61C 17/022; A61C 15/046; A61H 13/005
USPC 433/80

(57) ABSTRACT

An apparatus for oral hygiene includes a compartment which is adapted to store a cleaning fluid in a pressurized state. The compartment has a pressure sustaining mechanism which is manually operated, and is capable of maintaining the cleaning fluid in the pressurized state. Further, the apparatus includes a detachable delivery assembly which is operationally coupled to the compartment. The detachable delivery assembly is capable of being operated by a user for controllably ejecting the pressurized cleaning fluid at a high velocity from the compartment. The ejected cleaning fluid is capable of being used by the user for providing oral hygiene.

### FIELD OF THE INVENTION

The present invention generally relates to an apparatus for providing oral hygiene, and more particularly, to an apparatus for preventing, controlling and treating various dental diseases, such as, dental cavity and gum problems.

### BACKGROUND OF THE INVENTION

In our day to day lives, dental decay and gum problems have become major dental diseases. To combat these diseases, various oral hygiene aids have been developed.

One such aid is called an oral irrigator. It is used effectively for preventing, controlling and treating various dental diseases, such as dental cavity and gum problems, using the cleaning effects of a cleaning fluid, such as water. An oral irrigator is also called as dental water jet and is considered to be a higher form of oral hygiene aid amongst various dentists. However, it will be appreciated by those skilled in the art that there are only limited types of dental water jet available and these known in the art dental water jet have few inherent disadvantages.

Firstly, there are dental water jets which are operated by electricity or battery and hence they become non-operational in absence of electricity or wearing of batteries. The use of electricity and batteries also adds recurrent cost. Moreover, the motorized water jets are complex in manufacture and are very expensive in terms of buying or repairs. The cost forms a major hurdle for the patients to buy such oral irrigators for day to day purposes.

There are some designs of dental water jet where tubing of the dental water jets is connected to the tap, and the pressurized tap water is used as a jet stream to remove food debris from the mouth. However, the biggest problem with such design is reduced water pressure or irregular supply of the same. The non-electrical dental water jet may be highly needed in rural areas where electricity is a major problem.

Few non-electrical type dental water jets have been disclosed in patent prior art. In one such patent publication numbered DE3712981, a “Mouth Cleaning Syringe” is disclosed. The mouth cleaning syringe requires a syringe type mechanism for creating a water jet. A hand lever is coupled to a syringe. The hand lever is pressed by the user for redirected the stream of fluid trough the syringe.

Another such patent prior art is numbered US20100323321 and is titled “Portable Teeth Cleansing and Purging Device”. In this prior art, the disclosed apparatus requires a manually operated pump and an ejecting tube. The ejecting tube is a resilient tube having the ends mounted with a connector head and a purging head. The connector head is connected to the outer surrounding of a fluid outlet, and the purging head is a hollow tubing element. The end of the fluid outlet is a nozzle. By pressing and releasing of the pressing rod, the manual-operated pump is triggered to deliver a fixed amount of fluid supply via the fluid outlet, and as a result of restriction by the nozzle, a pressurized fluid stream for cleansing the gaps between the teeth.

However, in the above prior art any means for storing the sustained pressurized fluid is not disclosed. Further, the above prior art does not discloses a means by which fluid can be released from the dental water jet in a manner controllable by the user.

The present invention overcomes all the deficiencies of the above prior art.

### OBJECT OF THE INVENTION

An object of the present invention is to provide an apparatus for providing oral hygiene in which the apparatus is manually operated.

Another object of the present invention is to provide an apparatus which is portable because of its small size.

Yet another object of the present invention is to provide an apparatus which has very low cost of manufacturing.

Yet another object of the present invention is to provide an apparatus which is used to store a cleaning fluid in a pressurized state and the fluid may be released on desire of the user.

Yet another object of the present invention is to provide an apparatus which is manually operated and does not consume electricity or is battery operated

Yet another object of the present invention is to provide an apparatus which can be used by multiple users (for example, by multiple members of a family) for providing oral hygiene.

Yet another object of the present invention is to provide an apparatus which may be used easily by general population or physically challenged users.

These and other objects and advantages of the invention will be clear from the ensuing description.

### SUMMARY OF THE INVENTION

With respect to limitations set above, in one aspect, the present invention provides an apparatus for providing oral hygiene. The apparatus includes a compartment adapted to store a cleaning fluid in a pressurized state. The compartment is having a pressure sustaining mechanism which is manually operated and is capable of maintaining the cleaning fluid in the pressurized state. Further, the apparatus includes a detachable delivery assembly which is operationally coupled to the compartment. The detachable delivery assembly is capable of being operated by a user for controllably ejecting the pressurized cleaning fluid at a high velocity from the compartment on operation thereof. Wherein the cleaning fluid (39) ejected at high velocity is capable of being used by the user for providing oral hygiene.

In another aspect, the present invention provides an apparatus for providing oral hygiene. The apparatus includes at least one compartment adapted to store a cleaning fluid in a pressurized state. The compartment is having a pressure sustaining mechanism which is manually operated, wherein the pressure sustaining mechanism (500) is capable of maintaining the cleaning fluid in the pressurized state. The pressure sustaining mechanism includes at least one primary fluid reservoir for storing the cleaning fluid, at least one secondary fluid reservoir connected to the at feast one primary fluid reservoir via a connecting line. The at least one secondary fluid reservoir is adapted to be partially filled with the cleaning fluid. Further, the pressure sustaining mechanism includes a manually operated pressure pump operationally coupled to the at least one primary fluid reservoir, the at least one secondary fluid reservoir and the connecting line. The manually operated pressure pump is adapted to transfer the cleaning fluid from the at least one primary fluid reservoir to the at least one secondary fluid reservoir and for maintaining the cleaning fluid transferred from the at least one primary fluid reservoir to the at least one secondary fluid reservoir in the pressurized state. Further, the apparatus includes a detachable delivery assembly which is operationally coupled to the compartment. The detachable delivery assembly is capable of being operated by a user. The detachable delivery assembly is capable of ejecting the cleaning fluid at a high velocity from the compartment on operation thereof. The cleaning fluid, ejected at high velocity, is capable of being used by the user for providing oral hygiene.

This together with the other aspects of the present invention along with the various features of novelty that characterized the present disclosure is pointed out with particularity in claims annexed hereto and forms a part of the present invention. For better understanding of the present disclosure, its operating advantages, and the specified object attained by its uses, reference should be made to the accompanying descriptive matter in which there are illustrated exemplary embodiments of the present invention.

### DESCRIPTION OF THE DRAWINGS

The advantages and features of the present invention will become better understood with reference to the following detailed description taken in conjunction with the accompanying drawings, in which:

FIG. 1 illustrates a perspective view of the apparatus for providing oral hygiene, according to various embodiments of the present invention;

FIG. 2 illustrates a perspective view of the detachable delivery assembly employed in the apparatus, according to various embodiments of the present invention;

FIG. 3 illustrates one or more attachments that are capable of being fitted to the apparatus (1000), according to various embodiments of the present invention;

FIG. 4 illustrates a perspective view of the detachable fluid jet delivery handle (27) being detachable from the apparatus (10000);

FIG. 5 illustrates the apparatus being operated manually for providing the oral hygiene to the user, according to various embodiments of the present invention; and

FIG. 6 illustrates the apparatus operated manually by a pedal for providing hygiene, according to various embodiments of the present invention.

Like reference numerals refer to like parts throughout the description of several views of the drawing.

### DESCRIPTION OF THE INVENTION

For a thorough understanding of the present disclosure, reference is to be made to the following detailed description, including the appended claims. Although the present disclosure is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The terms “having”, “comprising” and “including” do not denote a limitation on the quantity of features referenced.

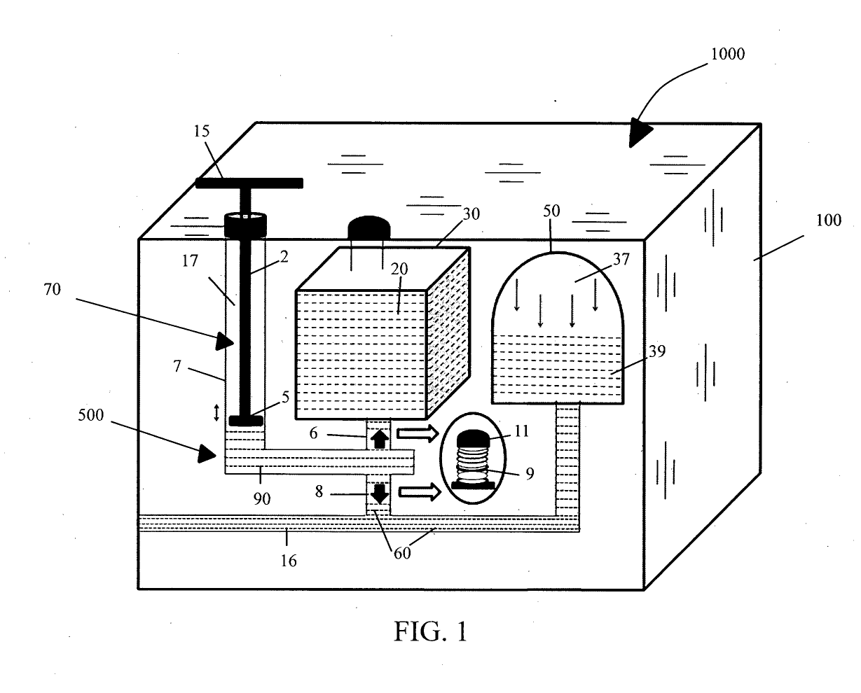

The present invention provides an apparatus for providing oral hygiene. The apparatus includes a compartment adapted to store a cleaning fluid in a pressurized state. The compartment is having a pressure sustaining mechanism which is manually operated and is capable of maintaining the cleaning fluid in the pressurized state. Further, the apparatus includes a detachable delivery assembly which is operationally coupled to the compartment. The detachable delivery assembly is capable of being operated by a user for controllably ejecting the pressurized cleaning fluid at a high velocity from the compartment on operation thereof. The apparatus and various parts thereof are shown in FIGS. 1-6.

As shown in the FIGS. 1-6, an apparatus (1000) for providing oral hygiene includes at least one compartment (100) adapted to store a cleaning fluid (20) in a pressurized state. The compartment (100) may be of any shape or size and may be composed of any metallic or non-metallic materials. In one embodiment, the compartment (100) may be cubical in shape and may be composed of polymeric materials so that it does not get corroded by the cleaning fluid (20) to be stored therein.

Specifically, the compartment (100) includes a pressure sustaining mechanism (500) for maintaining the cleaning fluid (20) in the pressurized state. It is proposed that any non-electrical or mechanical pressure sustaining mechanism may be employed in the present invention.

In one embodiment of the present invention, the pressure sustaining mechanism (500) includes at least one primary fluid reservoir (30) for storing the cleaning fluid (20). The primary reservoir (30) is similar to containers known in the art. Further, the primary reservoir (30) may be of any size or shape, and may be composed of any material, metallic or non-metallic in nature.

Further, the pressure sustaining mechanism (500) includes at least one secondary fluid reservoir (50) which is connected to the primary fluid reservoir (30). The at least one secondary fluid reservoir (50) is adapted to be partially filled with the cleaning fluid (20). The at least one secondary fluid reservoir (50) may be similar in construction to the primary fluid reservoir (30).

The pressure sustaining mechanism (500) may also include a connecting line (60) for operationally connecting the primary reservoir (30) and the secondary fluid reservoir (50) so that the cleaning fluid (20) may flow from the filled primary reservoir (30) to the secondary fluid reservoir (50) when required. The connecting line (60) may be similar to known in the art pipes used for transporting fluid and may be of any shape or size or may be made of any known in the art materials.

More specifically, the connecting line (60) includes at least one inlet valve (6) and at least one outlet valve (8). These valves (6) (8) may be used to controllably transport the cleaning fluid (20) from the filled primary reservoir (30) to the secondary fluid reservoir (50) when required. In one embodiment, the valves (6) (8) is a spring type one way valve or a check valve, and include a spring mechanism (9) and a stop cock (11) attached on top of the spring mechanism (9). The valves (6) (8) are fitted inside the connecting line (60) for regulating the flow of the cleaning fluid (20) from the primary reservoir (30) to the secondary reservoir (50) and building pressure on the fluid transferred inside the secondary reservoir (50). The valves (6) (8) may be composed of any material, and may be of any suitable size or shape. However, it should be understood that such example of the spring type valve should not be construed as a limitation to the present disclosure. Accordingly, any valve capable of acting as a check valve may be employed in the apparatus (1000).

Furthermore, the pressure sustaining mechanism (500) includes a manually operated pressure pump (70) which is operationally coupled to the primary fluid reservoir (30), the secondary fluid reservoir (50) and the connecting line (60), as shown in the FIG. 1. The construction of the manually operated pressure pump (70) will now be explained.

As shown in FIG. 1, the manually operated pressure pump (70) is adapted to transfer the cleaning fluid (20) from the primary fluid reservoir (30) to the secondary fluid reservoir (50), and to maintain the cleaning fluid (39) which is transferred from the primary fluid reservoir (30) to the secondary fluid reservoir (50) in the pressurized state.

Specifically, the manually operated pressure pump (70) includes a lever (15) which is capable of being operated by the user. The user may operate the lever (15) mechanically by either by his foot or hand. Further, the manually operated pressure pump (70) has a piston (17), which includes an elongated stem (2) extending from the lever (15), a piston head (5) distal to the lever (15), and a cylinder (7) which is adapted to allow the piston (17) to reciprocate freely therein for transferring the cleaning fluid (20) from the primary fluid reservoir (30) to the secondary fluid reservoir (50). The reciprocation of the piston (17) inside the cylinder (7) maintains the cleaning fluid (39) transferred from the primary fluid reservoir (30) to the secondary fluid reservoir (50) in the pressurized state.

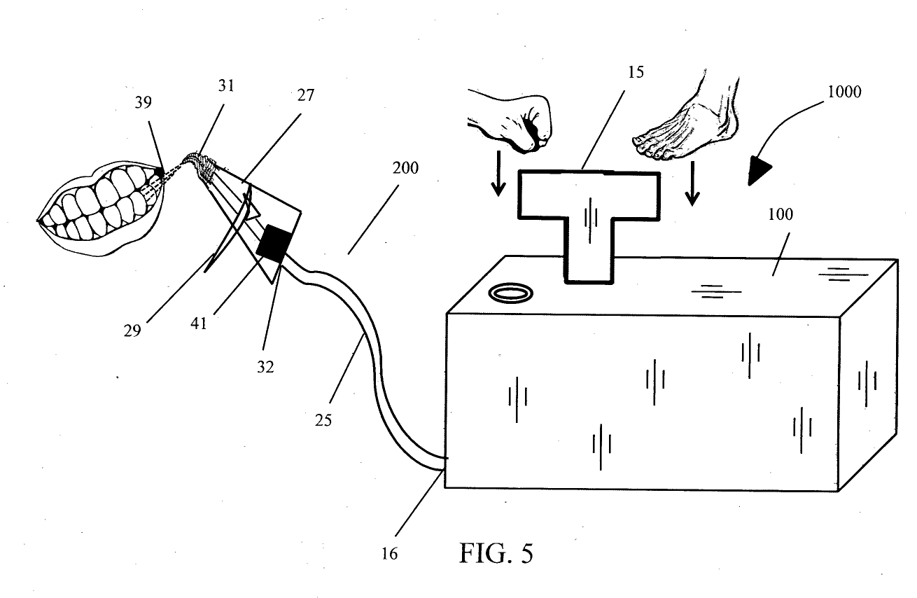

In one embodiment of the present invention, the lever (15) as mentioned herein refers to a handle, which may be operated by the user via his hands or foot, as shown in FIG. 5.

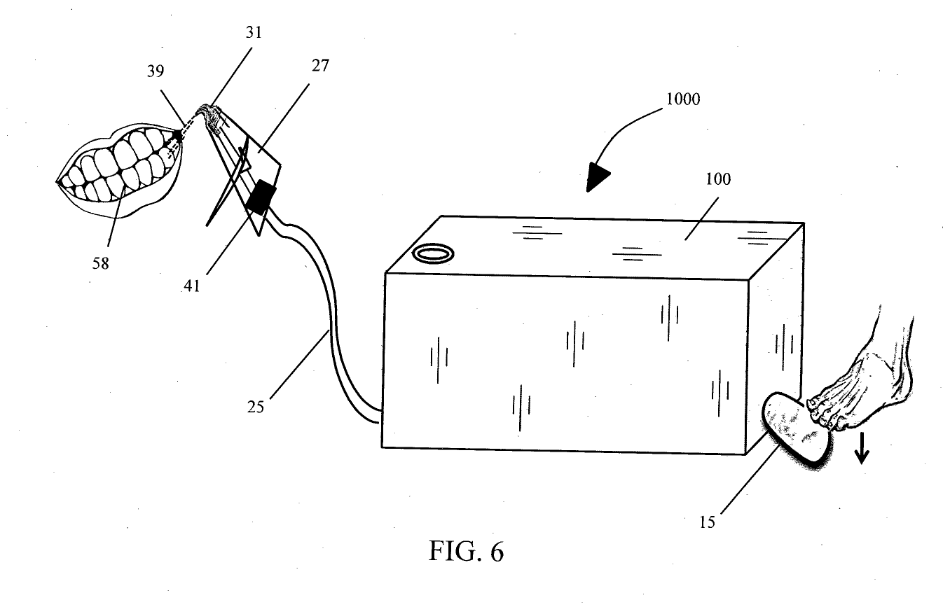

In another embodiment of the present invention, the lever (15) as mentioned herein refers to a pedal, which may be operated by the user via his feet, as shown in FIG. 6.

The transferred cleaning fluid (39) maintained in the pressurized state in the secondary reservoir (50) is capable of being controllably ejected at a high velocity on operation of the apparatus (1000) by the user.

Additionally, the apparatus (1000) includes a flexible tube (25) attached to the compartment (100), and particularly to a delivery line (16) of the compartment (100), wherein the flexible tube (25) is capable of allowing the pressurized cleaning fluid (39) stored in the at least one compartment (100) to flow there-from.

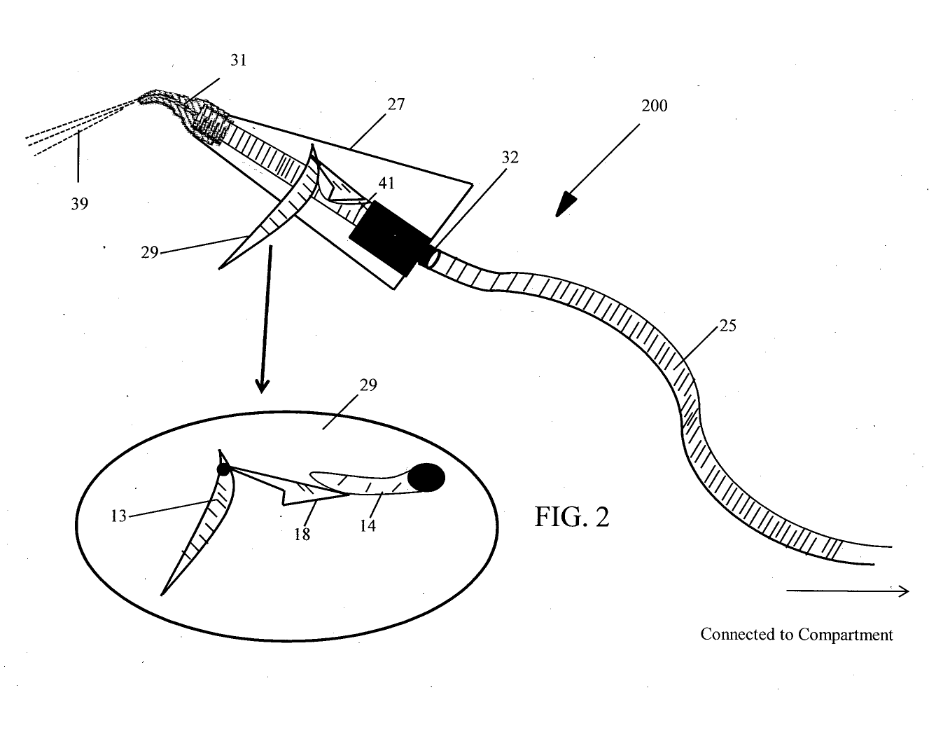

For enabling the ejected cleaning fluid to be used by the user to maintain oral hygiene, the apparatus (1000) includes a detachable delivery assembly (200), as shown in FIG. 2. The detachable delivery assembly (200) is operationally coupled to the compartment (100) via the flexible tube (25) of the compartment (100). Further, the detachable delivery assembly (200) is capable of being operated by a user for ejecting the pressurized cleaning fluid (39) at a high velocity from the compartment (100) on operation thereof.

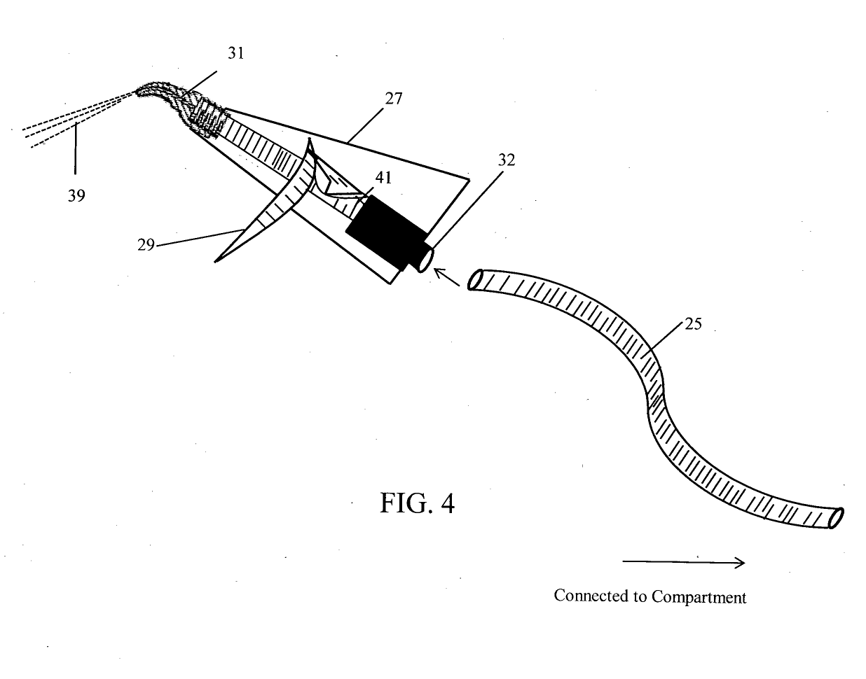

As shown in the FIG. 2, the detachable delivery assembly (200) (hereinafter called as “delivery assembly (200)”) includes a detachable fluid jet delivery handle (27) which is coupled at free end portion (32) of the flexible tube (25). The detachable fluid jet delivery handle (27) includes a conduit (41) coupled to the free end portion (32) of the flexible tube (25). The conduit (41) provides a channel for the transportation of the cleaning fluid (39) ejected from the compartment (100). The conduit (41) may be of any size or shape, and may be composed of any material, metallic or non-metallic in nature. In one embodiment, the detachable delivery assembly (200) is removably connected to the flexible tube (25) of the compartment (100) by at least one of magnets, ball and socket joint, threading mechanism and other means, as shown in FIG. 4. In other words, the detachable delivery assembly (200) may be removed from the apparatus (1000) and may be connected to the apparatus (1000) on wish of user. Accordingly, multiple users may be able to use the apparatus (1000) with their separate detachable delivery assembly (200).

Further, the detachable' fluid jet delivery handle (27) includes a tip (31) which is attached at free end portion (4) of the detachable fluid jet delivery handle (27). The tip (31) is capable of enhancing the effect of the cleaning fluid (39) ejected from the compartment (100). More specifically, the tip (31) is capable of providing the cleaning fluid (39) ejected from the compartment (100) in form of a jet stream (45). Further, the tip (31) is at least one of a straight tip or an angulated tip, or a variable angulation tip. Moreover, the tip (31) is composed of at least one of a rigid, a semi-rigid, or a flexible material.

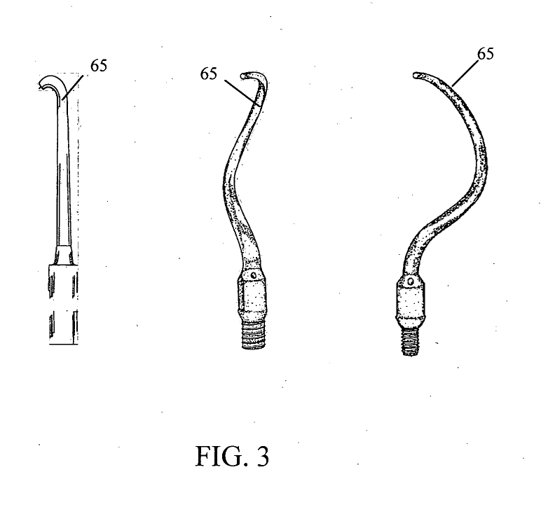

In one embodiment, the tip (31) as mentioned herein refers to a nozzle, as shown in FIG. 2. The nozzle may include one or more attachments (65) that are capable of being fitted thereto for enhancing the effect of the cleaning fluid (39) ejected from the at least one compartment (100), as shown in FIG. 3. The one or more attachments (65) may be a brush head, a bristle tuft, a inter-dental brush, a gum stimulator, a floss with floss holder, a needle of desired gauge, and a tongue.

The delivery assembly (200) further includes a releasing element (29) which is carried by the detachable fluid jet delivery handle (27). The releasing element (29) is capable of controlling the ejection of the cleaning fluid (39) at high velocity from the compartment (100) on being operated by the user.

In one embodiment, the releasing element (29) is a combination of a hand operated lever (13), a clasping arm (18) capable of snapping to the conduit (41) to choke flow of the cleaning fluid (39) being ejected from the compartment (100), and a spring mechanism (14) capable of controlling the movement of the clasping arm (18). The releasing element (29) may be of any size or shape, and may be composed of any material, metallic or non-metallic in nature. The delivery assembly (200) may also include a pressure valve for adjusting the pressure of the cleaning fluid (39) controllably ejected from the at least one compartment (100).

It should be clearly noted that any non-electrical or mechanical pressure sustaining mechanism may be employed in the present invention. Further, the above mentioned example of the pressure sustaining mechanism (500) should not be construed as a limitation to the present disclosure. Accordingly, in one embodiment, the pressure sustaining mechanism may be any other known in the art constant pressure based system. Such system may be set up similarly to the separate air pressure chamber system, but instead of relying on air pressure, water is pressurized from elastic nature of a rubber bladder; as the rubber is stretched, it exerts elastic contractile pressure to the water within. Due to the nature of elastic expansion and contraction, the amount of force applied to the water in the bladder throughout the contraction phase is nearly constant.

In another embodiment, the pressure sustaining mechanism may be elasticity based constant pressure system. Such system is similar to the aforesaid constant pressure based system in that it also uses the elasticity of rubber to provide the force behind the stream. However, unlike the constant pressure based system, such system has a rubber diaphragm stretched over a housing; as such, the bladder exerts notably more force when more fully expanded and the resulting stream pressure suffers from higher drop-off as the chamber contracts.

The working of the apparatus (1000) will now be explained. For using the apparatus (1000), the user may first fill the compartment (100) with the cleaning fluid (20). Specifically, the user may fill the primary fluid reservoir (30) with the cleaning fluid (20) by connecting to a water source. Thereafter, the user builds the pressure inside the compartment (100) with the help of the operating mechanism (500). More specifically, the user may use the manually operated pressure pump (70) to build the pressure inside the secondary fluid reservoir (50) of the compartment (100). The manually operated pressure pump (70) is operated by the user with the help of the handle or the pedal (lever 15), as shown in FIGS. 5 and 6, respectively. It will be apparent to a person skilled in the art that the primary fluid reservoir (30) and the secondary fluid reservoir (50) in the compartment (100) are connected with each other via a connecting line (60) as shown in FIG. 1. Further, the connecting line (60) has an inlet valve (6) and outlet valve (8) as shown in FIG. 1. The inlet valve (6) and the outlet valve (8) are used to regulate the flow of cleaning fluid (20) and maintain pressure in the compartment (100).

The pressure is build by the user through the manually operated pressure pump (70). More specifically, when the user pushes the lever (15) of the manually operated pressure pump (70) towards itself, the inlet valve (6) opens whereas the outlet valve (8) is closed. This way the cleaning fluid (20) is sucked from the primary fluid reservoir (30) and stored temporarily in a portion (90) of the connecting line (60). When the lever (15) is pushed inwardly by the user, the outlet valve (8) opens whereas the inlet valve (6) closes. The cleaning fluid (20) is thereafter transferred by the manually operated pressure pump (70) from the primary fluid reservoir (30) to the secondary fluid reservoir (50) where it is stored as the cleaning fluid (39).

It will be noted that the secondary fluid reservoir (50) is partially filled with air (37) and the cleaning fluid (39). During operation of the apparatus, the amount of the cleaning fluid (20) increases inside the secondary fluid reservoir (50). Therefore, the pressure inside the secondary fluid reservoir (50) starts building with increment of the cleaning fluid (20) flowing inside the secondary fluid reservoir (50), and as the air (37) in the secondary fluid reservoir (50) starts compressing the cleaning fluid (39) inside the secondary reservoir (50), thereby pressurizing the stored cleaning fluid (39). The outlet valve (8) at the secondary fluid reservoir (50) end helps in maintaining the cleaning fluid (39) in the pressurized state.

Further, the detachable delivery assembly (200) is operationally coupled to the compartment (100). The flexible tube (25) is attached to the compartment (100), and the releasing element (29) is, carried by the detachable fluid jet delivery handle (27). When the user pushes or presses the releasing element (29) in the detachable fluid jet delivery handle (27), the sustained pressure inside the secondary reservoir (50) releases the cleaning fluid (39) which is at the high pressure. More specifically, the releasing element (29) pushed or pressed by the user, opens the conduit (41) through which the cleaning fluid (39) is ejected at high velocity in form of the jet stream (45). This jet stream (45) ejected at high velocity is capable of being used by the user for providing oral hygiene. For example, the jet stream (45) ejected at high velocity is capable of being used by the user to clean teeth (58) of a patient. It will be apparent to those skilled in the art that flow of the ejected cleaning fluid (39) may be controllable by the operation of the releasing element (29) of the apparatus (1000). Further, the user may be able to create a continuous or an intermittent flow of the ejected cleaning fluid (39) in the apparatus (1000).

The apparatus (1000) as provided hereinabove provides unique advantages. Firstly, the apparatus (1000) is manually operated so the apparatus is used in every sectors where electricity supply is intermittent. Secondly, the apparatus (1000) is easy to use. Thirdly, the apparatus (1000) has a simple design and is easy to manufacture. Fourthly, the apparatus (1000) has very low cost of manufacturing. Fifthly, the apparatus (1000) is used to store a substantial amount of sustained pressure using non electrical means. Sixthly, the apparatus (1000) is portable because of its small size. The apparatus (1000) is effectively used for preventing, controlling and treating various dental diseases, to such as, dental cavity, gum problems. Also, the apparatus (1000) precludes the need of having the user keep pumping pressure every time he/she needs to need the apparatus as the internal compartment, such as the compartment (100), of the apparatus (1000) is already pressurized. The apparatus (1000) allows a water jet that can be ejected at a constant speed and intermittently (for creating a water hammer effect or pulsating effect) for a longer duration of time which is adequate for complete cleaning of teeth during maintaining oral hygiene. The apparatus (1000) reduces the dependability on pressure of tap water which is highly undependable. Lastly, the apparatus (1000) is preferably hand or foot operated, thereby being useful for general population or physically challenged patients.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

1. An apparatus for providing oral hygiene, the apparatus comprising:
at least one compartment adapted to store a cleaning fluid in a pressurized state, the at least one compartment having a pressure sustaining mechanism which is manually operated, wherein the pressure sustaining mechanism is capable of maintaining the cleaning fluid in the pressurized state; and
a detachable delivery assembly operationally coupled to the at least one compartment, the detachable delivery assembly capable of being operated by a user for controllably ejecting the pressurized cleaning fluid at a high velocity from the at least one compartment on operation thereof, and
wherein the cleaning fluid ejected at high velocity is capable of being used by the user for providing oral hygiene.

2. The apparatus of claim 1, wherein the pressure sustaining mechanism comprises,
at least one primary fluid reservoir for storing the cleaning fluid,
at least one secondary fluid reservoir connected to the at least one primary fluid reservoir via a connecting line, wherein the at least one secondary fluid reservoir is adapted to be partially filled with the cleaning fluid, and
at least one manually operated pressure pump operationally coupled to the at least one primary fluid reservoir, the at least one secondary fluid reservoir and the connecting line, wherein the at least one manually operated pressure pump is adapted to,
transfer the cleaning fluid from the at least one primary fluid reservoir to the at least one secondary fluid reservoir, and
maintain the cleaning fluid transferred from the at least one primary fluid reservoir to the at least one secondary fluid reservoir in the pressurized state, and
wherein the transferred cleaning fluid is controllably ejected at high velocity on operation of the detachable delivery assembly for being used by the user for providing oral hygiene.

3. The apparatus of claim 2, wherein the at least one manually operated pressure pump comprises,
a lever capable of being operated by the user,
a piston having,
an elongated stem extending from the lever, and
a piston head distal to the lever, and
a cylinder adapted to allow the piston to reciprocate freely therein for transferring the cleaning fluid from the at least one primary fluid reservoir to the at least one secondary fluid reservoir and maintaining the transferred cleaning fluid in the pressurized state.

4. The apparatus of claim 3, wherein the lever is a pedal.

5. The apparatus of claim 3, wherein the lever is a handle.

6. The apparatus of claim 1, wherein the at least one compartment comprises a flexible tube attached to the at least one compartment, wherein the flexible tube is capable of allowing the pressurized cleaning fluid stored in the at least one compartment to flow there-from.

7. The apparatus of claim 1, wherein the detachable delivery assembly comprises,
a detachable fluid jet delivery handle having a conduit coupled to the at least one compartment, and
a releasing element carried by the detachable fluid jet delivery handle and snapped to the conduit,
wherein the releasing element on being released by the user allows the pressurized cleaning fluid to be ejected at a high velocity from the at least one compartment via the conduit of the detachable fluid jet delivery handle.

8. The apparatus of claim 7, wherein the detachable fluid jet delivery handle comprises a tip which is attached at a free end portion of the detachable fluid jet delivery handle, wherein the tip is capable of enhancing the effect of the cleaning fluid ejected from the at least one compartment.

9. The apparatus of claim 8, wherein the tip is a nozzle.

10. The apparatus of claim 8, wherein the tip is at least one of a straight tip or an angulated tip, or a variable angulation tip.

11. The apparatus of claim 8, wherein the tip is composed of at least one of a rigid, a semi-rigid, or a flexible material.

12. The apparatus of claim 1 comprising one or more attachments capable of being fitted thereto for enhancing the effect of the cleaning fluid ejected from the at least one compartment, the one or more attachments are selected from a group consisting of, a brush head, a bristle tuft, a inter-dental brush, a gum stimulator, a floss with floss holder, a needle of desired gauge, and a tongue cleaner.

13. The apparatus of claim 1, wherein the cleaning fluid is water.

14. The apparatus of claim 1, wherein the cleaning fluid is a mixture of one or more cleansing chemical.

15. The apparatus of claim 1, comprising a pressure valve for adjusting the pressure of the cleaning fluid controllably ejected from the at least one compartment.

16. The apparatus of claim 1, wherein the pressure sustaining mechanism comprises,
at least one primary fluid reservoir for storing the cleaning fluid,
a connecting line, and
at least one manually operated pressure pump operationally coupled to the at least one primary fluid reservoir, and the connecting line, wherein the at least one manually operated pressure pump is adapted to maintain the cleaning fluid in the pressurized state, and
wherein the transferred cleaning fluid is controllably ejected at high velocity on operation of the detachable delivery assembly for being used by the user for providing oral hygiene.

17. The apparatus of claim 1, wherein the cleaning fluid is a gas.
